(19) United States
(12) Patent Application Publication
(10) Pub. No.: US 2010/0261149 A1
(43) Pub. Date: Oct. 14, 2010

(54) Web Tool

(76) Inventor: Pamela C. Eder, Barrington, IL (US)

Correspondence Address: Pamela C. Eder, 410 W. Oakwood Drive, Barrington, IL, 60010, US

(21) Appl. No.: 12/423,748

(22) Filed: Apr. 14, 2009

(51) Int. Cl. G09B 7/00; G09B 19/00

(52) U.S. Cl. 434/350; 434/236; 434/362

(57) ABSTRACT

A method for recording the process of an examinee performing a psychological test where the psychological test includes a finite number of elements that is to be sequentially manipulated. Such tests include memory tests or graphic manipulation tests such as copying complex figures. An observer uses a graphic or text input device, such as a computer, to register and store the time each manipulation is performed. In such a way, the process is accurately recorded in an ecologically valid manner.

### FIELD OF THE INVENTION

This invention relates generally to a diagnostic system and method with related device for testing one or more different psychological areas. The present invention is a method that allows for the recording of the process by which an examinee performs a multi-element psychological test. The principles and use of the method of the present invention may be better understood with reference to the drawings, the accompanying description and illustrative embodiments.

In general the method of the present invention is used when an examinee scores a psychological test while via the Internet or electronic system. According to the method of the present invention, an examinee performs a psychological test in a usual way with whatever tools are appropriate so that the test retains its ecological validity allowing for answers to be evaluated through electronic process. (through research correlation has been measured at 0.965)

When a test is completed, or when the time allocated for completing the test is up, a record describing the process by which the examinee performed the psychological test exists. The order and, in some cases the time, in which each separate step making up the test was performed is accurately recorded. Since the use of a graphic input device is quick, easy and intuitive, there is little examiner fatigue. As the data is directly stored in a database, analysis and scoring of the test can be swiftly and accurately performed without a time-consuming and error-prone data input step. Immediate data analysis or transmission is easily performed.

### BACKGROUND AND PRIOR ART

A web tool that allows doctors and psychologist to test for leaning disabilities via the web tool and the test is scored immediately. Tests can be assigned for a patient to take at home via the internet. Patient information, correspondence and diagnosis letters are within the scope of the tool.

It replaces the paper-and-pencil version of these tests. Paper-and-pencil tests must be taken and then scored by hand or sent out to be scored. This tool speeds up the process.

Each test is scored differently or using multiple question types. Usually using a Likert Scale with point values from 0-5, multiple choice, yes/no, true/false, short answer and long answer. Scores can be totaled as a whole. They also can be scored in sections. Each question can be assigned a value

### BRIEF DESCRIPTION OF THE DRAWINGS

FIG. 1 is an information flow chart

FIG. 2 is an information flow chart

FIG. 3 is an information flow chart

FIG. 4 is an information flow chart

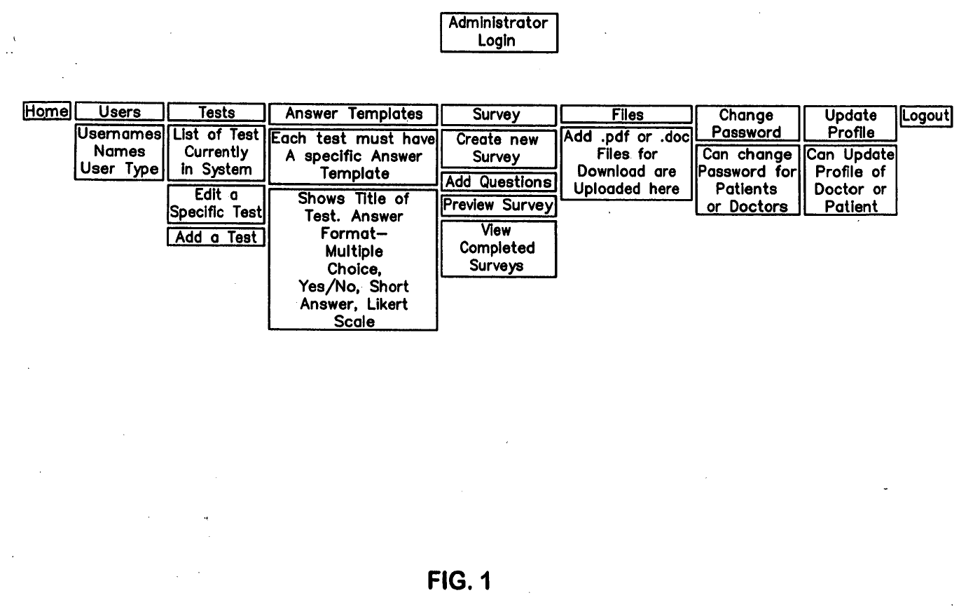

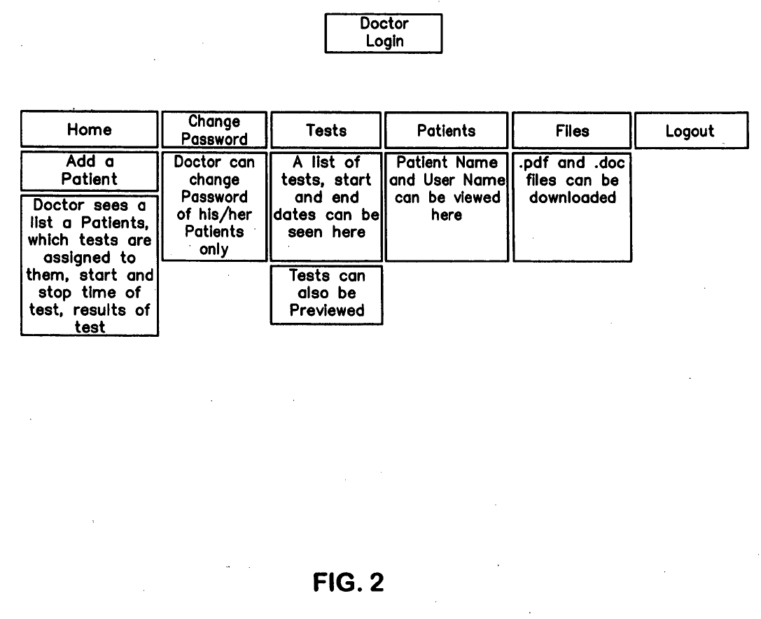

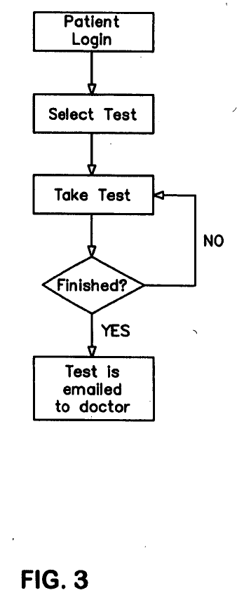

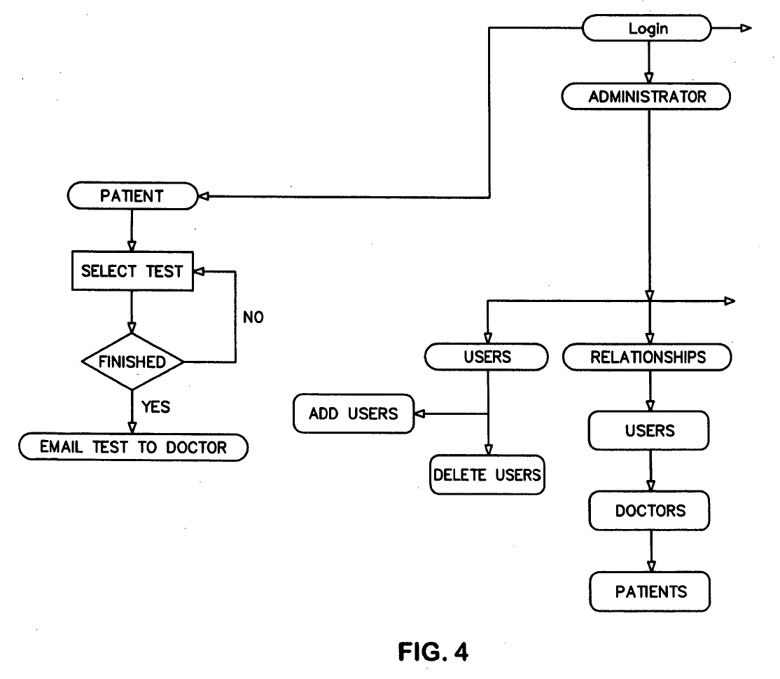

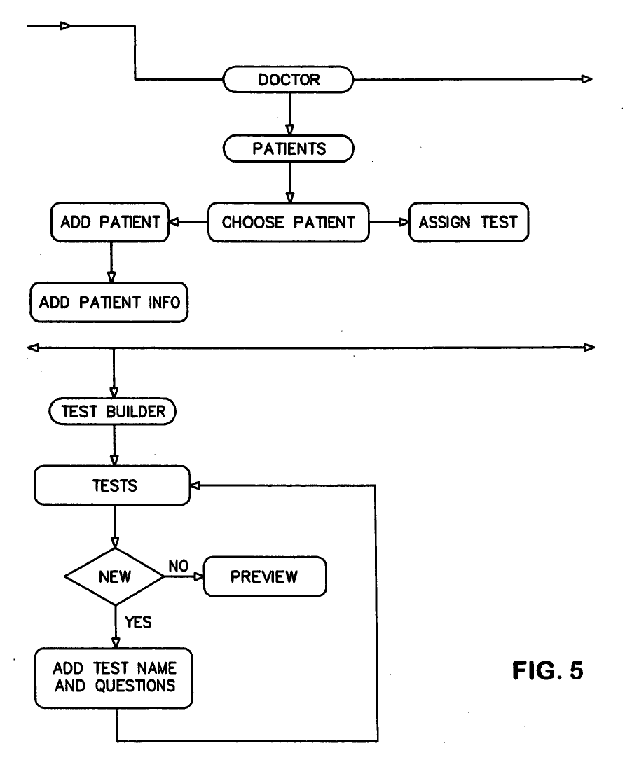

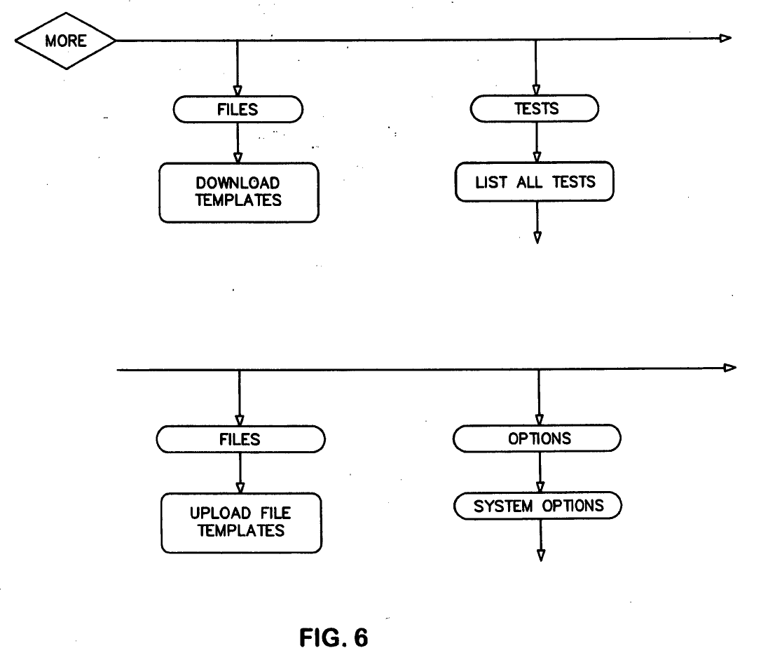

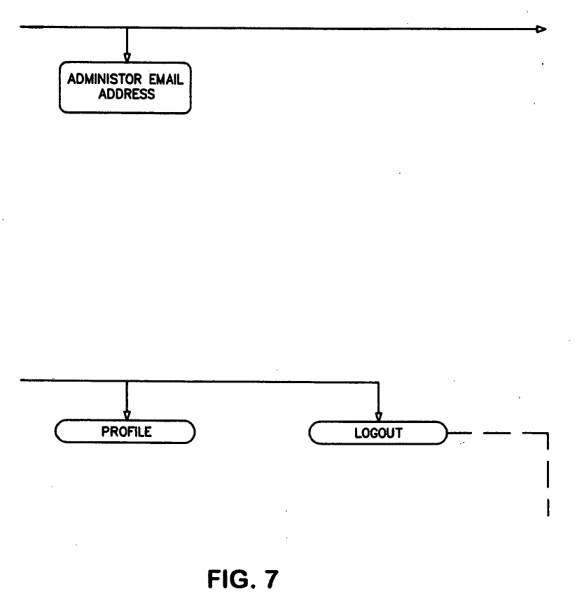

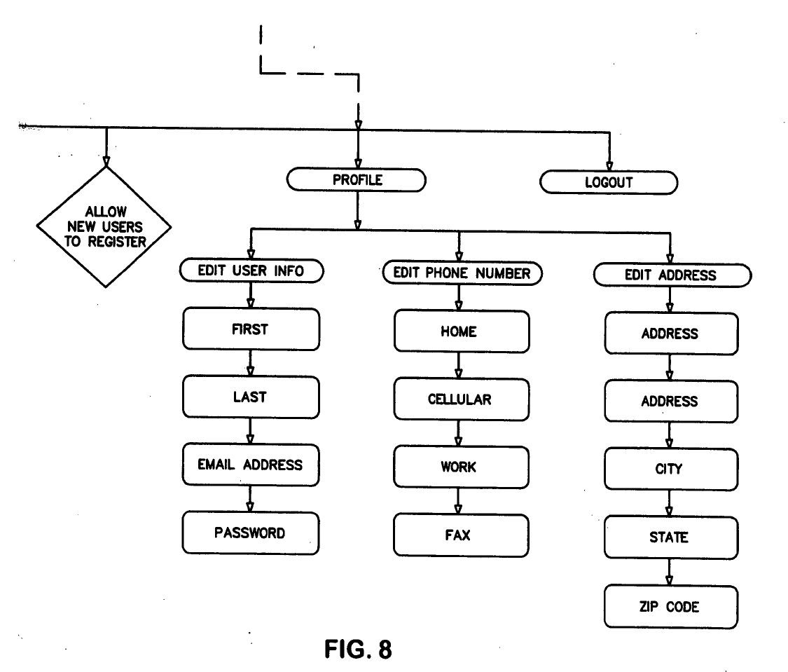

What is claimed is:

1. A method with related device for recording the process of an examinee performing a psychological test where the psychological test includes a finite number of elements that is to be sequentially manipulated, the method comprising the steps of which are:
(a) presenting a clinician or patient with at least one menu screen to allow the clinician to specify at least (i) a set of diagnostic data questions to be retrieved and displayed by the diagnostic system during the testing session with a patient, the set including at least one different diagnostic data records which correspond to at least one different display screens of the diagnostic system, and (ii) a viewing order for the display of the diagnostic data records of the set by the diagnostic system;
(b) recording the set and viewing order specified by the clinician in step (a) for subsequent use as at least a part of a custom follow-up protocol; thereafter, in response to clinician initiation of the custom follow-up protocol:
(c) automatically retrieving the diagnostic data records of the set from the test with the diagnostic system; and
(d) displaying the diagnostic data records of the set via corresponding display screens in the clinician-specified viewing order.

2. The method according to claim 1, wherein steps (a) through (d) are performed concurrently, so that the clinician can view the diagnostic data records of the patient for the purpose of determining learning disabilities.

3. The method according to claim 1, wherein when a test is completed, or when the time allocated for completing the test is up, a record describing the process by which the examinee performed the psychological test exists.
